(19) United States
(12) Patent Application Publication
(10) Pub. No.: US 2004/0103079 A1
(43) Pub. Date: May 27, 2004

(54) Method for operations management of database

(75) Inventors: Yoshitaka Tokusho, Tokyo (JP); Morihiro Iwata, Tama (JP); Kentaro Chigusa, Yokohama (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/445,491

(22) Filed: May 27, 2003

(30) Foreign Application Priority Data
Nov. 25, 2002 (JP) 2002-340272

(51) Int. Cl. G06F 7/00

(52) U.S. Cl. 707/1

(57) ABSTRACT

An operations management method for performing an operations management of a database, which is used by at least one of an application and a middleware is proved. In the operations management method, operations management information including execution details information and execution timing information required for performing the operations management of the database are registered in a database from at least one of the application and the middleware. At a specified time to start operations management of the application, a database operations management execution processing judges an execution timing for executing the operations management according to contents of the operations management information. At the execution timing of the operations management, the database operations management execution processing starts operating management utilities of the database to execute the operations management of the database.

### BACKGROUND OF THE INVENTION

1. Field of the Invention

The present invention relates to an operations management method of database in database management systems.

2. Related Background Art

In applications and middleware, such as system operations management software, document control software and storage management software, there is a demand to improve the reliability of data management. To this end, systems in such applications and middleware are often constructed using a database management system (DBMS).

In such systems, applications and middleware are linked to the DBMS in terms of data processing, but not in terms of operations management of the database. The link that the applications and middleware have with the DBMS makes it possible for processing and operations on the DBMS to be performed through the applications and middleware. The operations management of the database includes backing up the database and transaction log, reorganizing the database, expanding the database storage region, and recovering and tuning the database.

FIG. 16 indicates the relationship between an application and a DBMS as described in Date, C. J., An Introduction to Database Systems, 7th Edition, pp. 16, 41-43, 48-50, 83-84, Addison Wesley Longman, Inc., 2000. Since there are standard interfaces such as SQL for data processing, the applications and the DBMS are linked with each other through such interfaces. On the other hand, however, the applications and the DBMS are not linked with each other in terms of operations management, and a user must perform operations management with direct awareness of the DBMS.

Generally, acquiring a broad knowledge about DBMS and drafting or drawing up an operations management plan are required in order to perform operations management of database. For this reason, it is desirable for a database administrator to perform operations management. However, due to the fact that conventionally there are no clues for performing database management and details of operations management are unknown when a user of an application or middleware attempts to perform operations management, the operations management of database poses an additional burden on the user when the user employs services and functions provided by applications and middleware.

In this way, systems constructed using a DBMS according to prior art entail a problem of requiring a user to perform operations management of the database with direct awareness of the DBMS.

Consequently, in order to solve this problem, it must be made possible to perform operations management of the database without the user having to be directly aware of the DBMS, which is achieved by having the DBMS appropriately perform the operations management of the database.

However, there are various methods and procedures in the operations management of database, and they can vary considerably depending on the requirements of applications and middleware that use the database. For this reason, it is difficult according to prior arts for the DBMS to determine the appropriate method and/or procedure to perform operations management of the database.

### SUMMARY OF THE INVENTION

The present invention makes it possible to perform operations management of a database without the user having to directly aware of a DBMS by having the DBMS appropriately perform operations management of the database, which is achieved by linking applications and middleware to the DBMS.

In accordance with an embodiment of the present invention, an operations management of a database is executed by activating database operations management utilities in accordance with database operations management information, which is definition information that describes execution details and execution timing of operations management of the database required by applications and middleware.

The execution details of operations management described in the database operations management information are items and methods of the operations management to be executed, and the execution timing of operations management is a phenomenon that triggers an execution of operations management. Phenomena that become an execution timing include the arrival of a specific time and passage of a certain amount of time, the reception of a specific alert from a DBMS, and a specific condition regarding internal information of a database or system being met.

The database operations management information is created by developers of applications or middleware according to the requirements of such applications or middleware. For example, in a DBMS used by an application that performs processing only during daytime and does not perform any processing at night, operations management of the database such as backups and reorganization is done at night. Accordingly, database operations management information to execute offline (i.e., a state in which access to the database is denied) operations management at night is created for such an application.

On the other hand, for a DBMS used by an application that is to operate continuously 24 hours, 365 days, online database operations management is performed in parallel with application processing. For this reason, database operations management information to execute online (i.e., a state in which access to the database is accepted) operations management during periods of time when there is little processing performed on the application is created for such an application.

The database operations management information consists of the following information:

(1) The timing to execute an operations management: This indicates a phenomenon that triggers the execution of an operations management of a database. Such phenomena include the arrival of a specific time and passage of a certain amount of time, the reception of a specific alert from a DBMS, and a specific condition regarding internal information of a database or system being met.

(2) Details of an operations management to be executed: This indicates items and methods of the operations management of the database to be executed. Specifically, this refers to a script (various simple programs, such as shell scripts and batch files) that describes one or more database operations management utilities that are activated to execute the operations management and their order of activation.

The database operations management method according to the present invention includes the following steps:

(1) Upon receiving an instruction from an application, the database operations management information is stored in a database operations management information storage region and registered in a DBMS.

(2) Once an instruction is received from the application to begin a database operations management execution processing, the database operations management execution processing obtains the database operations management information registered and determines the execution timing for the operations management.

(3) When the execution timing of the operations management becomes applicable, the database operations management execution processing activates database operations management utilities, which causes the database operations management utilities to execute the operations management of the database.

(4) Messages outputted by the DBMS, such as termination status or a message from the database operations management utilities, are transmitted to the application via a database operations management interface.

Through these steps, the DBMS becomes capable of performing operations management of the database based on the database operations management information created by the developer of the applicable application. As a result, the operations management of the database takes place without the user of the application having to be directly aware of the DBMS.

Other features and advantages of the invention will become apparent from the following detailed description taken in conjunction with the accompanying drawings.

### BRIEF DESCRIPTION OF THE DRAWINGS

FIG. 1 shows the principle of an operations management method of database in accordance with the present invention.

FIG. 2 schematically shows the configuration of a system in accordance with a first embodiment of the present invention.

FIG. 3 is a flowchart indicating the procedure for executing an operations management of database according to the first embodiment.

FIG. 4 is a flowchart of a database operations management information registration program according to the first embodiment.

FIG. 5 shows an example of database operations management information according to the first embodiment.

FIG. 6 is a flowchart of a database operations management execution program according to the first embodiment.

FIG. 7 schematically shows the configuration of a system in accordance with a second embodiment of the present invention.

FIG. 8 shows an example of database operations management information in accordance with the second embodiment.

FIG. 9 is a flowchart of a database operations management execution program according to the second embodiment.

FIG. 10 schematically shows the configuration of a system in accordance with a third embodiment of the present invention.

FIG. 11 shows an example of database operations management information in accordance with the third embodiment.

FIG. 12 is a flowchart of a database operations management execution program according to the third embodiment.

FIG. 13 schematically shows the configuration of a system in accordance with a fourth embodiment of the present invention.

FIG. 14 shows an example of database operations management information according to the fourth embodiment.

FIG. 15 is a flowchart of a database operations management execution program according to the fourth embodiment.

FIG. 16 indicates the relationship between an application and a DBMS according to the conventional art.

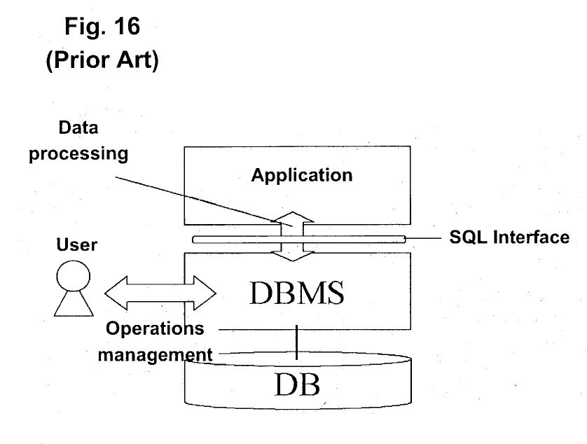

FIG. 17 indicates an overall processing procedure of a message transmission program according to the first embodiment.

### DESCRIPTION OF THE PREFERRED EMBODIMENTS

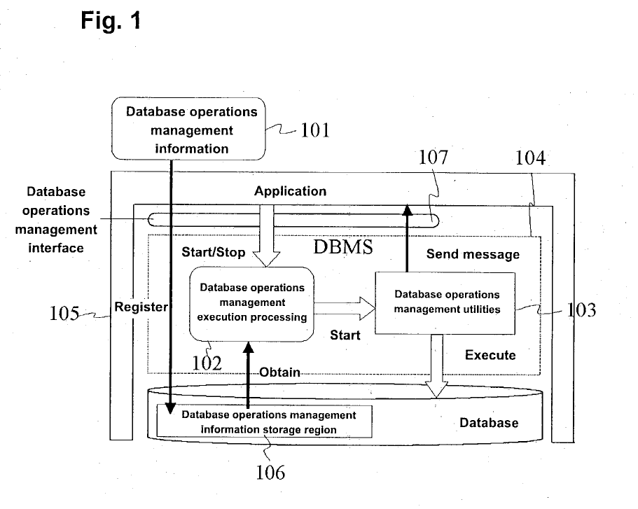

FIG. 1 indicates the principle of the present invention. The database operations management method according to the present invention consists of the following steps:

(1) Database operations management information 101 is transferred from an application 105 via a database operations management interface 107 and stored in a database operations management information storage region 106 and registered in a DBMS (database management system) 104. The DBMS 104 is used not only by the one application 105, but is used by other applications as well, and operations management unique to the DBMS 104 based on such a usage mode is performed on it. The present invention provides a mechanism to link applications, which are executed while internally utilizing a DBMS, to a DBMS, whose operations management takes place based on the sharing of the DBMS by a plurality of applications, in terms of processing in relation to operations management.

(2) Once an instruction is received via the database operations management interface 107 from the application 105 to begin a database operations management execution processing, a database operations management execution processing 102 obtains the database operations management information 101 registered and determines the execution timing for the operations management.

(3) When the execution timing of the operations management becomes applicable, the database operations management execution processing 102 activates database operations management utilities 103, which causes the database operations management utilities 103 to execute the operations management of the database.

(4) Messages outputted by the DBMS 104, such as termination status or a message from the database operations management utilities 103, are transmitted to the application 105 via the database operations management interface 107.

Through these steps, the DBMS 104 becomes capable of performing operations management of the database based on the database operations management information 101 created by the developer of the application 105. As a result, the operations management of the database takes place without the user of the application 105 having to be directly aware of the DBMS 104. Although an example in which the DBMS 104 is incorporated into the application 105 is described in the present embodiment, the present invention can be applied to situations in which the DBMS 104 is incorporated into a middleware shared by a plurality of applications.

The database operations management information consists of the following information:

(1) The timing to execute an operations management: This indicates a phenomenon that triggers the execution of an operations management of a database. Such phenomena include the arrival of a specific time and passage of a certain amount of time, the reception of a specific alert from a DBMS, and a specific condition regarding internal information of a database or system being met.

(2) Details of an operations management to be executed: This indicates items and methods of the operations management of the database to be executed. Specifically, this refers to a script (i.e., various simple programs, such as shell scripts and batch files) that describes one or more database operations management utilities that are activated to execute the operations management and their order of activation.

Preferred Embodiment 1:

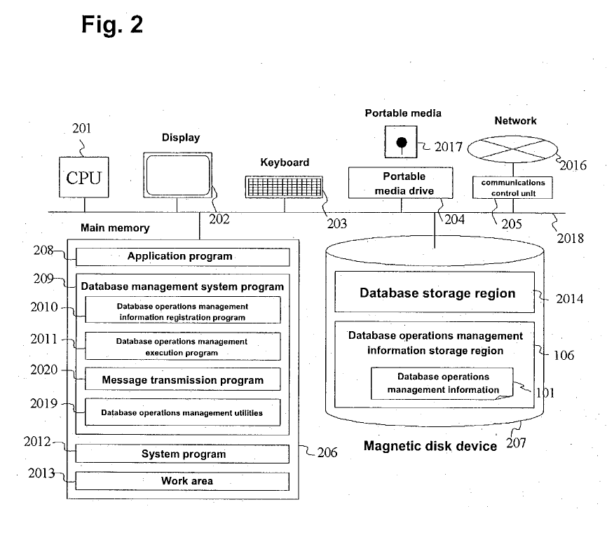

FIG. 2 is a block diagram of a system in accordance with a first embodiment of the present invention.

A computer system that implements a database operations management method according to the present embodiment as indicated in FIG. 2 consists of a central processing unit (CPU) 201, a display 202, a keyboard 203, a portable medium drive 204, a communications control unit 205, a main memory 206, a magnetic disk device 207, and a system bus 2018. The computer system according to the present invention has a configuration similar to general computer systems.

The CPU 201 executes various programs used in the present invention. The display 202 is used to display execution status and execution results of processing. The keyboard 203 is used to input commands for instructing an execution of a database management system. The portable medium drive 204 is used to read and write data to and from a portable medium 2017, such as a flexible disk, optical magnetic disk or write-once-read-many disk. The communications control unit 205 is used in communications via a network 2016. The main memory 206 is used to store various programs and temporary data used in the present invention. The magnetic disk device 207 is used to store database and definition information concerning the database. The system bus 2018 is used to connect these units to each other. The magnetic disk device 207 contains a database storage region 2014 and the database operations management information storage region 106.

The database storage region 2014 is used to store database and definition information concerning the database. The database operations management information storage region 106 is used to store the database operations management information 101.

The database operations management information 101 is definition information that describes execution details and execution timing for operations management of database required for an application program 208; the database operations management information 101 is stored in the database operations management information storage region 106 by a database operations management information registration program 2010 and read by a database operations management execution program 2011.

In the main memory 206 are retained the application program 208, a database management system program 209, a system program 2012 and a work area 2013.

The application program 208 provides services to users by utilizing functions provided by the database management system program 209. In addition, the application program 208 instructs the database management system program 209 to register the database operations management information 101 and to begin and end operations management of the database.

The database management system program 209 consists of the database operations management information registration program 2010, the database operations management execution program 2011, a group of database operations management utilities 2019, and a message transmission program 2020. The database management system program 209 opens to the application program 208 the database operations management interface 107 when issuing such instructions as an instruction to register the database operations management information 101 and an instruction to activate or stop the database operations management execution program 2011.

The database operations management information registration program 2010 stores in the database operations management information storage region 106 secured in the magnetic disk device 207 the database operations management information 101 transferred via the database operations management interface 107 from the application program 208. The database operations management execution program 2011 obtains the database operations management information 101 stored in the database operations management information storage region 106 and activates the group of database operations management utilities 2019 according to the details described in the database operations management information 101.

The group of database operations management utilities 2019 is a gathering of programs that execute such operations management as backing up the database and transaction log, reorganizing the database, and expanding the database storage region. The group of database operations management utilities 2019 is similar to utilities in general DBMSs.

The message transmission program 2020 transmits termination status and messages outputted by the group of database operations management utilities 2019 to the application program 208 via the database operations management interface 107.

The system program 2012 provides basic functions, such as input/output of data with peripheral equipment, that are required for executing various programs used in the present invention. In addition, the system program 2012 has an internal system clock and retains the current date and time. The work area 2013 is used to store data that are temporarily required to execute programs.

The programs used in the present invention are set in the main memory 206 via the network 2016 or in the portable medium 2017.

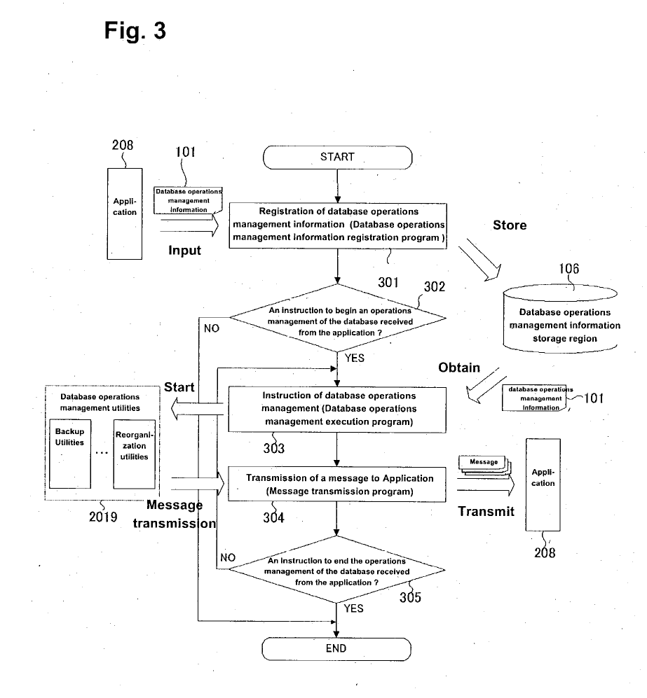

FIG. 3 is a flowchart indicating the overall procedure for executing operations management of a database according to the first embodiment of the present invention. The procedure for executing the operations management of the database is as follows:

(1) The database operations management information 101 that was transferred from the application program 208 via the database operations management interface 107 is stored in the database operations management information storage region 106 (step 301).

(2) Whether an instruction to begin an operations management of the database has been received from the application program 208 via the database operations management interface 107 is determined (step 302).

(3) If it is determined in (2) that the instruction to begin the operations management of the database has been received, the processing proceeds to (4); if it is determined that the instruction has not been received, the entire processing is terminated.

(4) The database operations management information 101 is obtained from the database operations management information storage region 106 and the group of database operations management utilities 2019 is activated (step 303).

(5) Upon receiving a termination status or a message outputted by the group of database operations management utilities 2019, the message is sent to the application program 208 via the database operations management interface 107 (step 304).

(6) Whether an instruction to terminate the operations management of the database has been received from the application program 208 via the database operations management interface 107 is determined (step 305).

(7) If it is determined in (6) that the instruction to terminate the operations management of the database has been received, the entire processing is terminated; if it is determined that the instruction has not been received, the processing returns to (4).

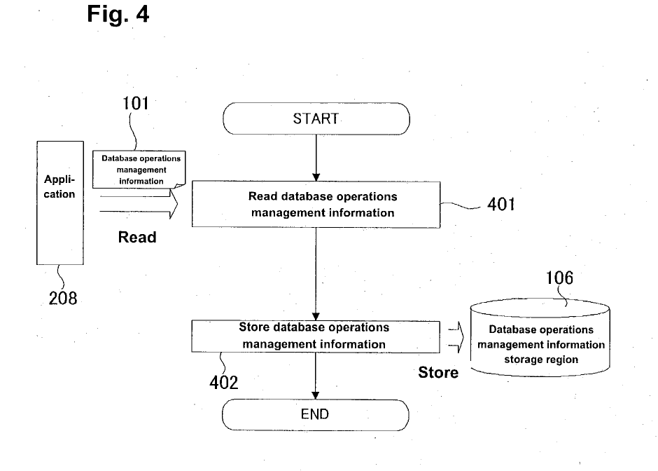

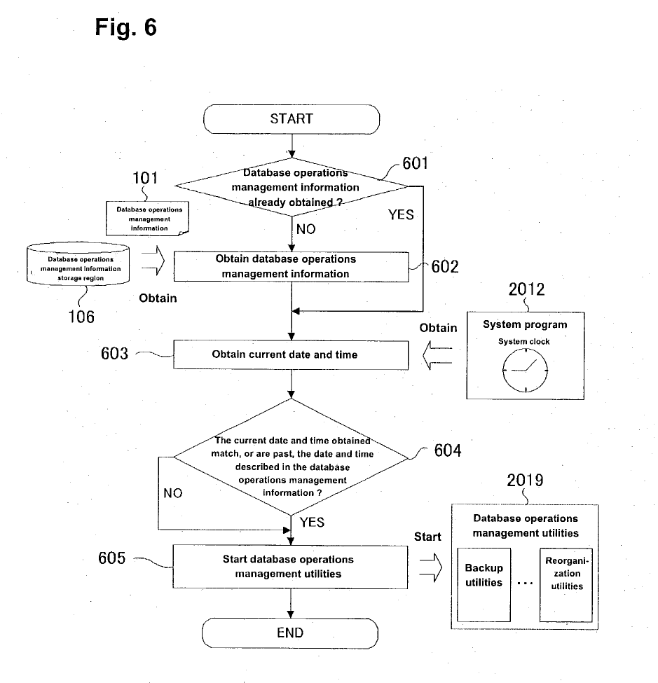

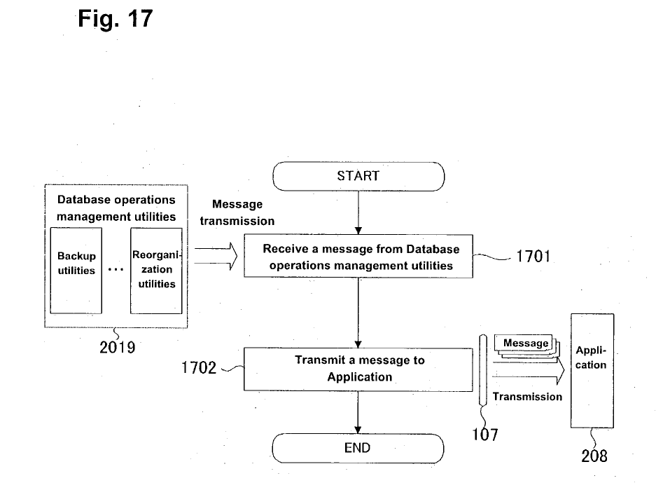

In this procedure, step 301 is performed by the database operations management information registration program 2010. The processing procedure performed by the database operations management information registration program 2010 is described in FIG. 4. Step 303 is performed by the database operations management execution program 2011. The processing procedure performed by the database operations management execution program 2011 is described in FIG. 6. Step 304 is performed by the message transmission program 2020. The processing procedure performed by the message transmission program 2020 is described in FIG. 17.

FIG. 4 is a flowchart indicating the overall processing procedure performed by the database operations management information registration program 2010 (step 301 in FIG. 3) according to the first embodiment of the present invention. The processing procedure performed by the database operations management information registration program 2010 is as follows:

(1) The database operations management information 101 inputted from the application program 208 via the database operations management interface 107 is read (step 401).

(2) The database operations management information 101 is stored in the database operations management information storage region 106 (step 402).

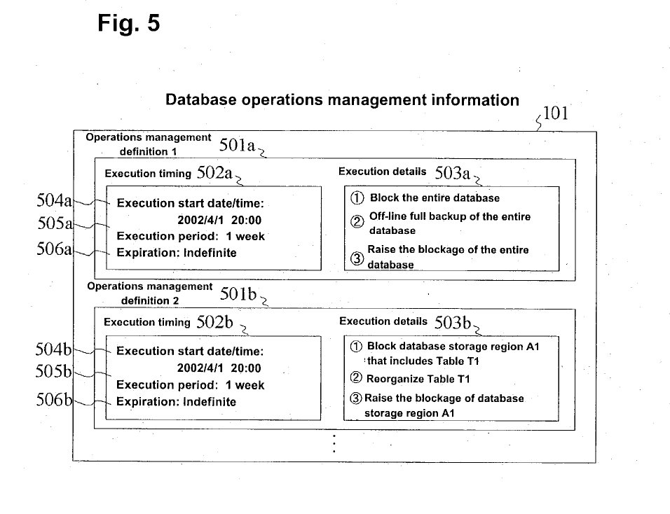

FIG. 5 is an example of the database operations management information 01 according to the first embodiment of the present invention. In the present embodiment, the database operations management information 101 is one in which the execution timing for an operations management is that the current time is a specific time or that a certain amount of time has passed.

The database operations management information 101 in FIG. 5 consists of one or more operations management definitions 501 (501a and 501b). Each operations management definition 501 consists of an execution timing field 502 (502a or 502b) and an execution detail field 503 (503a or 503b).

The contents of the execution timing field 502 indicate whether the operations management is to be performed repeatedly on a periodic basis or to be performed once on a specific date and time. If it is to be performed repeatedly on a periodic basis, the following are indicated: the date and time to begin the operations management, the interval of period between executions of the operations management, and expiration within which to repeatedly execute the operations management. If the operations management is to be performed at least once on a specific date and time, the date and time on which to execute the operations management are indicated.

The execution timing field 502 includes the following items:

(1) An execution beginning date and time 504: This indicates the date and time on which to begin the execution of an operations management.

(2) An execution period 505: This indicates the interval of period between executions if the operations management is to be executed repeatedly on a certain periodic basis. If the operations management is to be performed only once on a specific date and time, the execution period 505 has no expiration.

(3) An expiration 506: This indicates as a date and time the expiration for repeatedly executing the operations management. The expiration 506 of an operations management may be indefinite, in which case the expiration for repeatedly executing an operations management is not specified.

Although the fact that a specific time has arrived and that a certain amount of time has passed are indicated by the three items (1) the execution beginning date and time 504, (2) the execution period 505, and (3) the expiration 506 in FIG. 5, information in other formats may be used as long as it expresses that a specific time has arrived and that a certain amount of time has passed.

The execution detail field 503 indicates the details and an execution instruction procedure of an operations management to be performed using the group of database operations management utilities 2019.

For example, the operations management definition 1 (501 a) of the database operations management information 101 in FIG. 5 indicates that an offline backup is to be performed for the entire database on a weekly periodic basis beginning at 8:00 PM on Apr. 1, 2002. In this example, the procedure for the offline backup is as follows: (1) block the entire database; (2) obtain an offline backup of the entire database; and (3) subsequently raise the blockade of the entire database. Although the details and procedure of the operations management of the execution detail field 503 in FIG. 5 are described in natural language, they can be described as commands of corresponding database operations management utilities using scripts such as shell scripts and batch files.

The database operations management information 101 in FIG. 5 indicates only those information required for describing the present embodiment but it may contain additional information, or it may be expressed as information in other formats as long as it can obtain information that indicates the timing to execute an operations management and the details of the operations management to be executed. Further, the database operations management information 101 in FIG. 5 can be interactively inputted via the application program 208 using the display 202 and the keyboard 203.

FIG. 6 is a flowchart indicating the overall processing procedure performed by the database operations management execution program 2011 (step 303 in FIG. 3) according to the first embodiment of the present invention. The processing procedure performed by the database operations management execution program 2011 is as follows:

(1) Whether the database operations management information 101 has been obtained is checked (step 601).

(2) If it is determined in (1) that the database operations management information 101 has been obtained, the processing proceeds to (4); if it has not been obtained, the processing proceeds to (3).

(3) The database operations management information 101 is obtained from the database operations management information storage region 106 (step 602).

(4) The current date and time are obtained from the system clock within the system program 2012 (step 603).

(5) Whether the current date and time obtained in (4) match, or are past, the date and time described in the execution timing field 502 of the database operations management information 101 is checked (step 604).

(6) If it is determined in (5) that the current date and time either match or are past the date and time described in the execution timing field 502 of the database operations management information 101, the processing proceeds to (7); if it is determined that they neither match nor are past the date and time described in the execution timing field 502, the processing is terminated.

(7) The group of database operations management utilities 2019 is activated in accordance with the instruction procedure described in the execution detail field 503 of the database operations management information 101 (step 605).

FIG. 17 is a flowchart indicating the overall processing procedure performed by the message transmission program 2020 (step 304 in FIG. 3) according to the first embodiment of the present invention. The processing procedure performed by the message transmission program 2020 is as follows:

(1) A termination status or message outputted by the group of database operations management utilities 2019 is received (step 1701).

(2) The termination status or message received is sent to the application program 208 via the database operations management interface 107 (step 1702).

By exchanging information through the message transmission program 2020, the group of database operations management utilities 2019 and the application program 208 become linked to make it possible to perform operations management of the database.

As described above, according to the operations management method of database according to the present embodiment, by registering in a DBMS from an application or middleware the database operations management information whose execution timing is that the current time is a specific time and that a certain amount of time has passed, and by having the DBMS perform the operations management of the database in accordance with the database operations management information, users of the application or middleware can perform the operations management of the database, such as reorganization or backup that is performed on a specific date and time or repeatedly on a certain periodic basis, without being directly aware of the DBMS.

Furthermore, the execution status of the database operations management, such as whether the execution timing is applicable and messages from the group of database operations management utilities 2019 to the application program 208, is displayed on the display 202 via the application program 208, and instructions concerning database operations management can be inputted via the application program 208 using the keyboard 203.

Preferred Embodiment 2:

In accordance with a second embodiment of the present invention, the execution timing in the database operations management information according to the first embodiment is changed to the reception of a specific alert outputted from a query processing program included in a DBMS.

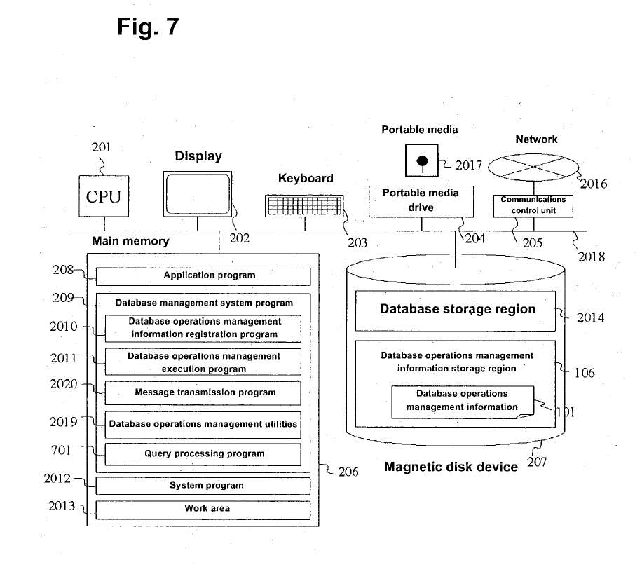

FIG. 7 is a block diagram of a system according to the second embodiment of the present invention.

The configuration of a computer system indicated in FIG. 7 that implements a database operations management method according to the present embodiment is almost identical to the configuration indicated in FIG. 2.

A database management system program 209 contains a query processing program 701 in addition to the programs shown in FIG. 2. The query processing program 701 is a program that accepts query requests to a database from an application program 208 or a group of database operations management utilities 2019 and sends back the result of the corresponding processing to the request source. The group of database operations management utilities 2019 and the query processing program 701 are similar to utilities and programs contained in general DBMSs.

The flowchart indicating the overall procedure for executing the operations management of a database according to the second embodiment of the present invention is the same as the flowchart in FIG. 3 according to the first embodiment.

The flowchart indicating the overall processing procedure of a database operations management information registration program 2010 according to the second embodiment of the present invention is the same as the flowchart in FIG. 4 according to the first embodiment.

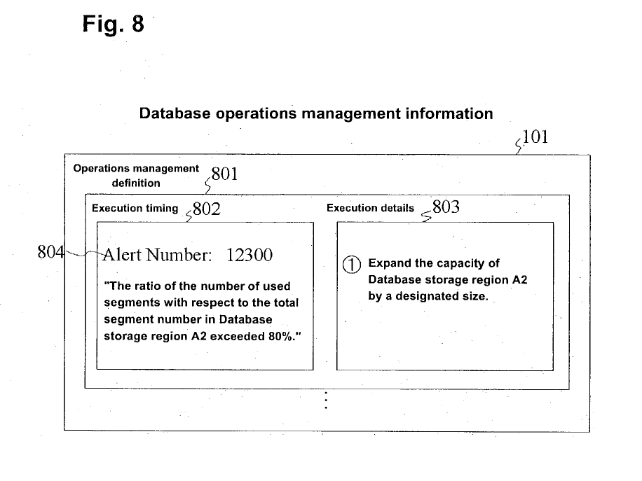

FIG. 8 is an example of database operations management information 101 according to the second embodiment of the present invention.

In the database operations management information 101 in the present embodiment, the execution timing for an operations management is the reception of a specific alert outputted by the query processing program 701. An alert refers to a notice issued by the query processing program 701 to a database operations management execution program 2011 regarding a failure that has occurred inside the database. Failures that occur inside the database specifically refer to insufficient database storage regions, reduction in database storage efficiency, reduction in search efficiency or the like, whose levels may be set in advance. In general, an output of an alert notifying the occurrence of such failures serves as the timing to perform an expansion of database storage regions, a reorganization of database, or a tuning of various parameters such as the size of database buffer region.

The database operations management information 101 in FIG. 8 consists of one or more operations management definition 801. Each operations management definition 801 consists of an execution timing field 802 and an execution detail field 803.

The content of the execution timing field 802 indicates an alert 804 whose reception is awaited. When the alert 804 described in the execution timing field 802 of the database operations management information 101 is received, the database operations management execution program 2011 instructs the execution of the operations management of the database. The execution timing field 802 includes information that uniquely identifies the alert 804, such as the alert number and content to be outputted by the query processing program 701.

Although the alert is identified using the alert number and content in FIG. 8, information in other formats may be used as long as it can uniquely identify the alert.

Furthermore, although only one alert is listed as the execution timing in the execution timing field 802 in FIG. 8, if an operations management is instructed to be executed when any one of a plurality of different alerts is received, or if an operations management is instructed to be executed when all of the alerts described are received, the plurality of alerts can be combined with an OR or AND operator and designated appropriately in the execution timing field 802.

The execution detail field 803 indicates the details and an execution instruction procedure of an operations management to be performed using the group of database operations management utilities 2019.

For example, the operations management definition 801 of the database operations management information 101 in FIG. 8 indicates that when an alert number 12300 with the alert that “The ratio of the number of used segments to the total number of segments in the database storage region A2 has exceeded 80%” outputted from the query processing program 701 is received by the database operations management execution processing program 2011, an expansion processing of the region size of the database storage region A2 is to be performed.

Although the details of the operations management of the execution detail field 803 in FIG. 8 are described in natural language, they can be described as commands of corresponding database operations management utilities using scripts such as shell scripts and batch files.

The database operations management information 101 in FIG. 8 indicates only those information required for describing the present embodiment but it may contain additional information, or it may be expressed as information in other formats as long as it can obtain information that indicates the timing to execute an operations management and the details of the operations management to be executed.

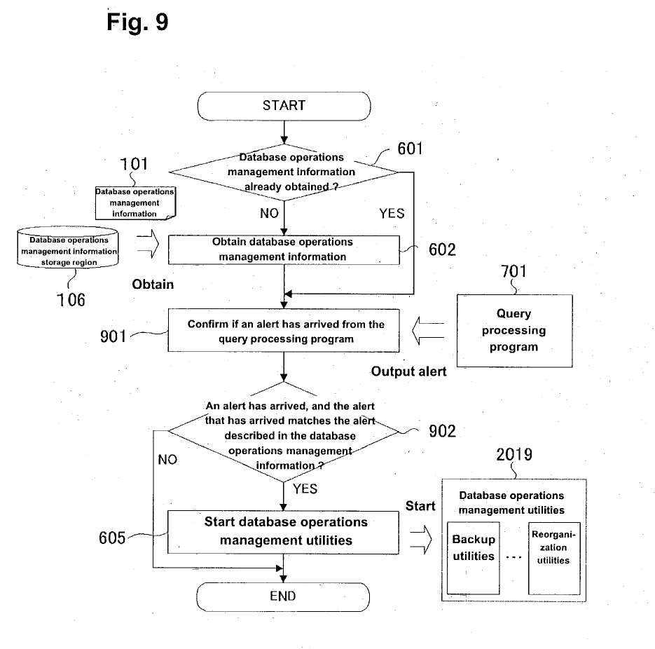

FIG. 9 is a flowchart indicating the overall processing procedure performed by the database operations management execution program 2011 according to the second embodiment of the present invention. The processing procedure performed by the database operations management execution program 2011 is as follows:

(1) The processing for obtaining the database operations management information 101 is the same as in FIG. 6 (steps 601 and 602).

(2) Whether an alert has arrived from the query processing program 701 to the database operations management execution program 2011 is checked (step 901).

(3) Whether the alert has arrived from the query processing program 701 and whether the alert that has arrived matches the alert described in the execution timing field 802 of the database operations management information 101 are checked (step 902).

(4) If it is determined in (3) that the alert has arrived and matches the alert described in the execution timing field 802, the processing proceeds to (5); if the alert has not arrived or has arrived but does not match the alert described in the execution timing field 802, the processing is terminated.

(5) The group of database operations management utilities 2019 is activated in accordance with the instruction procedure described in the execution detail field 803 of the database operations management information 101 (step 605).

The flowchart that indicates the overall processing procedure of a message transmission program 2020 according to the second embodiment of the present invention is the same as the flowchart in FIG. 17 according to the first embodiment.

As described above, according to the operations management method of database according to the present embodiment, by registering in a DBMS from an application or middleware the database operations management information whose execution timing is the reception of an alert from a query processing program, and by having the DBMS perform the operations management of the database in accordance with the database operations management information, users of the application or middleware can perform the operations management, which takes place when an alert regarding a problem that has occurred inside the database is received, without being directly aware of the DBMS.

Preferred Embodiment 3:

In accordance with a third embodiment of the present-invention, the execution timing in the database operations management information according to the first embodiment is changed to a specific condition regarding internal information of a system or database being met.

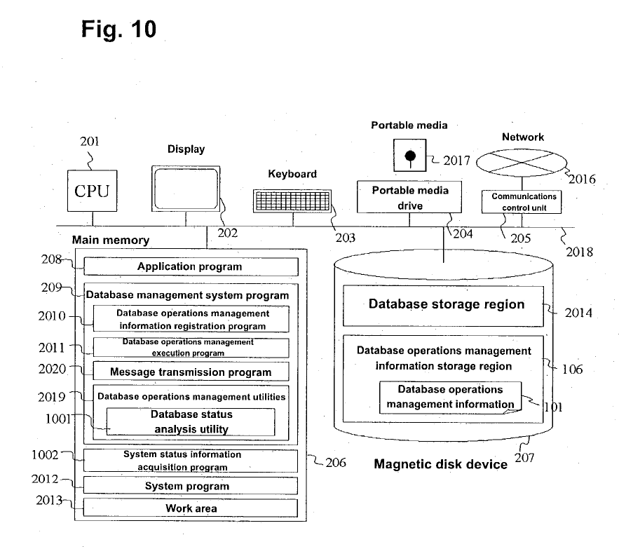

FIG. 10 is a block diagram of a system according to the third embodiment of the present invention.

The configuration of a computer system indicated in FIG. 10 that implements a database operations management method according to the present embodiment is almost identical to the configuration indicated in FIG. 2.

A main memory 206 contains a system status information acquisition program 1002 in addition to the programs shown in FIG. 2.

A group of database operations management utilities 2019 is a gathering of programs that execute such operations management as backing up a database and transaction log, reorganizing the database, expanding the database storage region, and analyzing the status inside the database. The group of database operations management utilities 2019 contains a database status analysis utility 1001.

The database status analysis utility 1001 is a program that collects internal information of the database, such as the sizes of used and free regions of a database storage region 2014 and the storage efficiency of data stored in the database storage region 2014, and reports the results to other programs.

The group of database operations management utilities 2019 and the database status analysis utility 1001 are similar to utilities contained in general DBMSs.

The system status information acquisition program 1002 is a program that obtains information regarding internal status of a system, such as the usage rate of a CPU 201 of the computer system and I/O rate of a magnetic disk device 207, and reports the results to other programs.

The flowchart indicating the overall procedure for executing the operations management of a database according to the third embodiment of the present invention is the same as the flowchart in FIG. 3 according to the first embodiment.

The flowchart indicating the overall processing procedure of a database operations management information registration program 2010 according to the third embodiment of the present invention is the same as the flowchart in FIG. 4 according to the first embodiment.

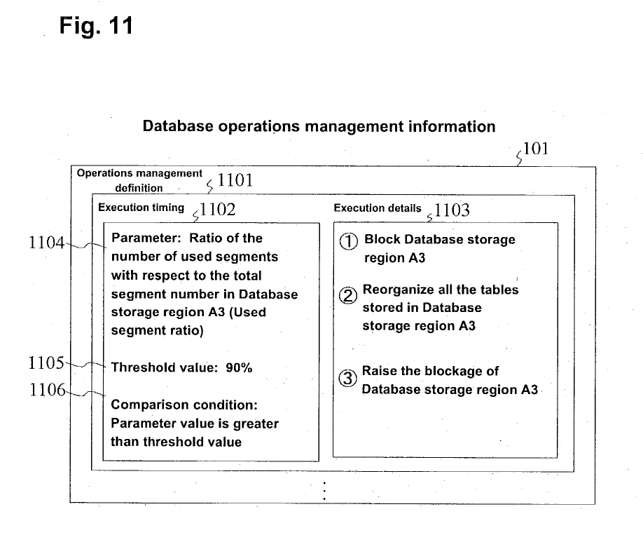

FIG. 11 is an example of database operations management information 101 according to the third embodiment of the present invention.

In the database operations management information 101 according to the present embodiment, the execution timing of an operations management is a specific condition regarding internal information of a system or database being met. The internal information of a system refers to status information, statistical information and operation information about a system, such as CPU operating rate, disk I/O ratio, and network operating rate. The internal information of a database refers to status information, statistical information and operation information about a database, such as the usage rate of storage regions of the database, data storing order consecutive rate, and the page hit rate of a database cache.

In general, by setting in advance thresholds for internal information of a system or database, operations management, such as reorganization and tuning and whose objective is to enhance the performance of the database, can be executed when a criterion that the value of such internal information exceeds or falls below the threshold is met.

FIG. 11 consists of one or more operations management definition 1101. Each operations management definition 1101 consists of an execution timing field 1102 and an execution detail field 1103.

The execution timing field 1102 indicates criteria for internal information of a system or database. A database operations management execution program 2011 obtains internal information of a system or database using status information collection commands of an OS and/or status analysis utilities of a DBMS and evaluates the criteria in order to determine whether the execution timing of an operations management is applicable.

The execution timing field 1102 includes three items: (1) a parameter 1104, (2) a threshold 1105, and (3) a comparison condition 1106.

The (1) parameter 1104 indicates the internal information of a system or database on which a condition is determined in comparison to the threshold 1105. The (2) threshold 1105 indicates the threshold of the parameter described in (1). The (3) comparison condition 1106 indicates a criterion based on a comparison between the values of the (1) parameter and the (2) threshold.

Although the criterion for internal information of a system or database is described in three items of (1) parameter, (2) threshold and (3) comparison condition in FIG. 11, information in other formats may be used as long as a criterion for internal information of a system or database can be expressed as the execution timing for an operations management.

Furthermore, although only one criterion is listed as the execution timing in the execution timing field 1102 in FIG. 11, if an operations management is instructed to be executed when any one of a plurality of criteria is met, or if an operations management is instructed to be executed when all of the criteria are met, the plurality of criteria can be combined with an OR or AND operator and described in the execution timing field 11102.

The execution detail field 1103 indicates the details and an execution instruction procedure of an operations management to be performed using the group of database operations management utilities 2019.

For example, the operations management definition 1 (1101) of the database operations management information 101 in FIG. 11 indicates that all tables in a database storage region A3 are to be reorganized when an execution condition, which is that the ratio of the number of segments used to the total number of segments in the database storage region A3 (i.e., the used segment ratio) exceeds the 90% threshold, is met. The procedure for reorganizing of the database in this example is as follows: (1) shut down the database storage region A3; (2) reorganize all tables in the database storage region A3; and (3) release the shutdown of the database storage region A3. Although the details and procedure of the operations management of the execution detail field 1103 in FIG. 11 are described in natural language, in reality they are described as commands of corresponding database operations management utilities using scripts such as shell scripts and batch files.

The database operations management information 101 in FIG. 11 indicates only those information required for describing the present embodiment but it may contain additional information, or it may be expressed as information in other formats as long as it can obtain information that indicates the timing to execute an operations management and the details of the operations management to be executed.

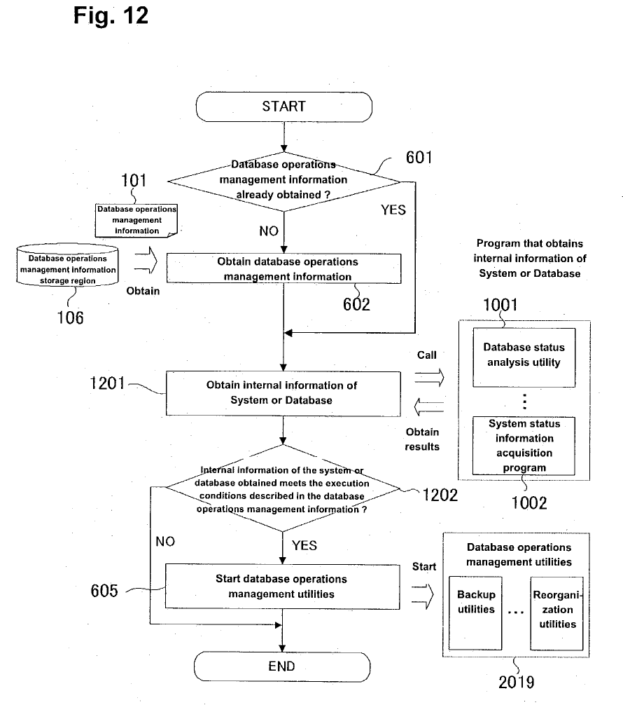

FIG. 12 is a flowchart indicating the overall processing procedure performed by the database operations management execution program 2011 according to the third embodiment of the present invention. The processing procedure performed by the database operations management execution program 2011 is as follows:

(1) The processing for obtaining the database operations management information 101 is the same as in FIG. 6 (steps 601 and 602).

(2) Programs that collect internal information of a system or database, such as the database status analysis utility 1001 and/or the system status information acquisition program 1002, are called, and internal information of the system or database is obtained (step 1201).

(3) Whether the internal information of the system or database obtained meets the criterion described in the execution timing field 1102 of the database operations management information 101 is checked (step 1202).

(4) If it is determined in (3) that the internal information of the system or database obtained meets the criterion described in the execution timing field 1102, the processing proceeds to (5); if the internal information of the system or database obtained does not meet the criterion, the processing is terminated.

(5) The group of database operations management utilities 2019 is activated in accordance with the instruction procedure described in the execution detail field 1103 of the database operations management information 101 (step 605).

The flowchart that indicates the overall processing procedure of a message transmission program 2020 according to the third embodiment of the present invention is the same as the flowchart in FIG. 17 according to the first embodiment.

As described above, according to the operations management method of database according to the present embodiment, by registering in a DBMS from an application or middleware the database operations management information whose execution timing is that a criterion regarding internal information of a system or database is met, and by having the DBMS perform the operations management of the database in accordance with the database operations management information, users of the application or middleware can perform the operations management, which takes place when the criterion regarding internal information of the system or database is met, without being directly aware of the DBMS.

Preferred Embodiment 4:

In accordance with a embodiment of the present invention, the execution timing in the database operations management information according to the first embodiment is changed to the occurrence of a phenomenon in which are combined three phenomena of the arrival of a specific time and passage of a certain amount of time, the reception of a specific alert outputted by a query processing program, and a certain condition regarding internal information of a system or database being met.

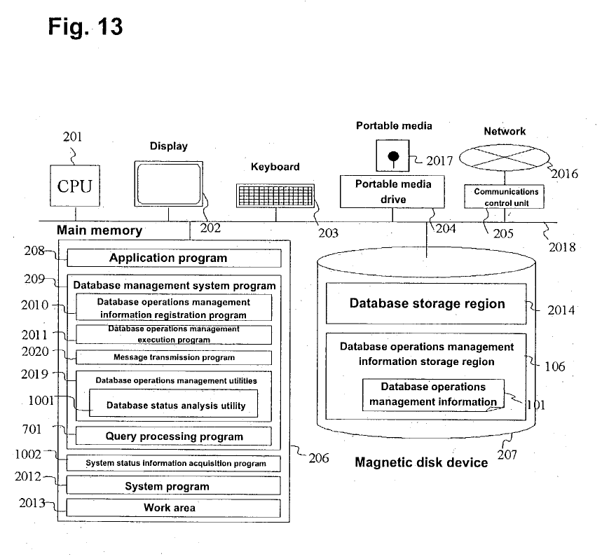

FIG. 13 is a block diagram of a system according to the fourth embodiment of the present invention.

The configuration of a computer system indicated in FIG. 13 that implements a database operations management method according to the present embodiment is almost identical to the configuration indicated in FIG. 2.

A main memory 206 contains a system status information acquisition program 1002 in addition to the programs shown in FIG. 2.

The database management system program 209 contains a query processing program 701 in addition to the programs shown in FIG. 2.

A group of database operations management utilities 2019 is a gathering of programs that execute such operations management as backing up a database and transaction log, reorganizing the database, expanding the database storage region, and analyzing the status inside the database. The group of database operations management utilities 2019 contains a database status analysis utility 1001.

The database status analysis utility 1001 is a program that collects internal information of the database, such as the sizes of used and free regions of a database storage region 2014 and the storage efficiency of data stored in the database storage region 2014, and reports the results to other programs.

The query processing program 701 is a program that accepts query requests to a database from an application program 208 or a group of database operations management utilities 2019 and sends back the results of the corresponding processing to the request source.

The group of database operations management utilities 2019, the database status analysis utility 1001, and the query processing program 107 are similar to utilities and programs contained in general DBMSs.

The system status information acquisition program 1002 is a program that obtains information regarding internal status of a system, such as the usage rate of a CPU 201 of the computer system and I/O rate of a magnetic disk device 207, and reports the results to other programs.

The flowchart indicating the overall procedure for executing the operations management of database according to the fourth embodiment of the present invention is the same as the flowchart in FIG. 3 according to the first embodiment.

The flowchart indicating the overall processing procedure of a database operations management information registration program 2010 according to the fourth embodiment of the present invention is the same as the flowchart in FIG. 4 according to the first embodiment.

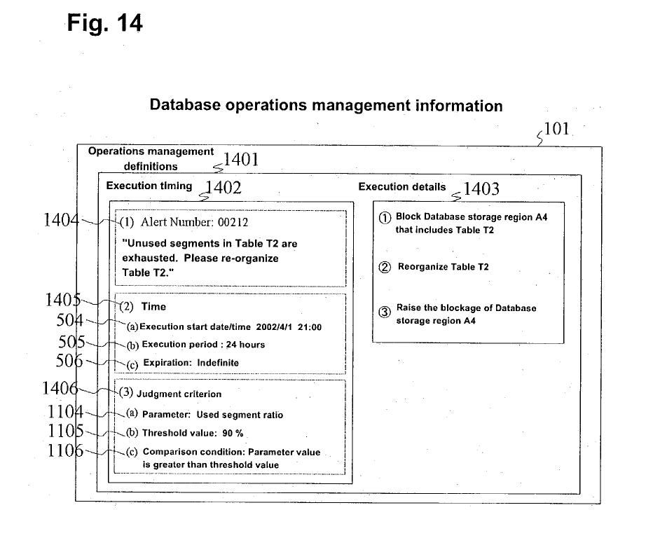

FIG. 14 is an example of database operations management information 101 according to the fourth embodiment of the present invention.

In the database operations management information 101 according to the present embodiment, the execution timing of an operations management is the occurrence of a phenomenon in which are combined three phenomena of the arrival of a specific time and passage of a certain amount of time, the reception of a specific alert outputted by the query processing program 701, and a certain condition regarding internal information of a system or database being met.

Specifically, in the present embodiment, we will describe the database operations management information 101 that describes an operations management that is to be executed when a specific alert outputted from the query processing program 701 is received and a specific condition regarding internal information of a database is subsequently met when a specific time arrives. In a DBMS used by an application that performs processing only during business hours in the daytime and does not perform any processing outside business hours such as at night, if the query processing program 701 outputs a specific alert during the business hours, such database operations management information 101 can be used to perform an operations management prompted by the output of the alert as necessary at the end of the day's business hours.

The database operations management information 101 in FIG. 14 consists of one or more operations management definition 1401. Each operations management definition 1401 consists of an execution timing field 1402 and an execution detail field 1403.

The contents of the execution timing field 1402 indicate information on the alert, information on the time, and information on the criterion that are the execution timing for an operations management. The execution timing field 1402 include the following three items: (1) an alert 1404, (2) a time 1405, and (3) a criterion 1406.

The (1) alert 1404 indicates the number and detail of an alert to be sent from the query processing program 701. The (2) time 1405 indicates information that specifies the time at which an instruction to execute an operational processing is issued. The time 1405 includes as its sub-items an execution beginning date and time 504, an execution period 505, and an expiration 506. The (3) criterion 1406 indicates a criterion based on a comparison of internal information of the database with a threshold set for the internal information. The criterion 1406 includes as its sub-items a parameter 1104, a threshold 1105, and a comparison condition 1106.

The execution detail field 1403 indicates the details and an execution instruction procedure of an operations management to be performed using the group of database operations management utilities 2019.

For example, the operations management definition 1401 of the database operations management information 101 in FIG. 14 indicates that a table T2 is to be reorganized when an alert number 00212 with the alert that “There are no more unused segments in the table T2. Reorganize the table T2” is received, the time is past 21:00, and a condition that “the number of used segments in the database storage region exceeds 90%” is met. In other words, when the alert (alert number: 00212) prompting reorganization is received, whether a condition concerning internal information of a database is met is determined in order to decide whether the execution of the reorganization is required. If as a result of determining the condition, it is determined that the reorganization is required, the execution of the reorganization is instructed; if it is determined that the organization is not required, the execution of the reorganization is not instructed.

Although the details and procedure of the operations management of the execution detail field 1403 in FIG. 14 are described in natural language, in reality they are described as commands of corresponding database operations management utilities using scripts such as shell scripts and batch files.

In FIG. 14, the execution timing is the occurrence of all three phenomena of the reception of an alert, the arrival of a certain time, and a criterion being met, but a different combination, such as having only one of the three phenomena occur, may also be the execution timing. Alternatively, the execution timing may be a partial combination of the phenomena, such as combining only the arrival of a certain time and a criterion being met.

The database operations management information 101 in FIG. 14 indicates only those information required for describing the present embodiment but it may contain additional information, or it may be expressed as information in other formats as long as it can obtain information that indicates the timing to execute an operations management and the details of the operations management to be executed.

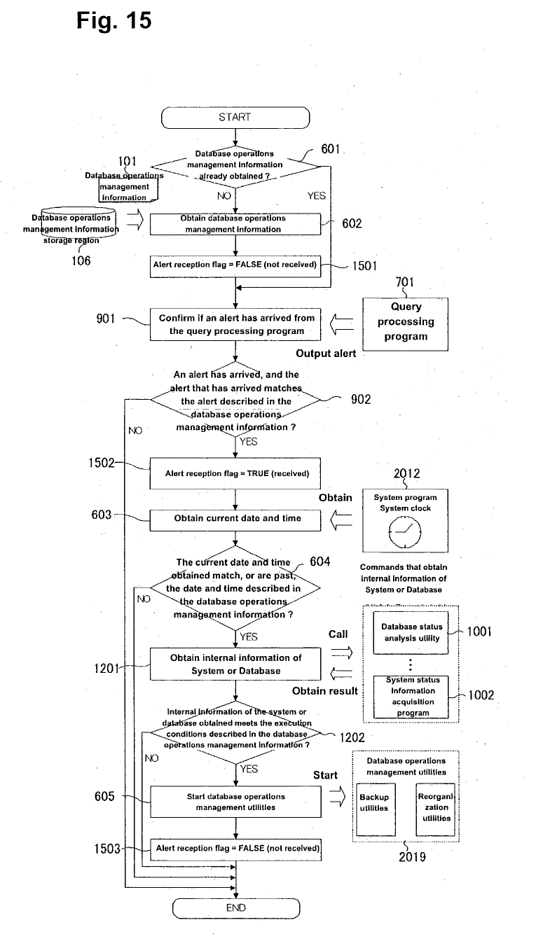

FIG. 15 is a flowchart indicating the overall processing procedure performed by a database operations management execution program 2011 according to the fourth embodiment of the present invention. The processing procedure performed by the database operations management execution program 2011 is as follows:

(1) The processing for obtaining the database operations management information 101 is the same as in FIG. 6 (steps 601 and 602).

(2) An alert reception flag is set to FALSE (step 1501).

(3) Whether the alert has arrived from the query processing program 701 to the database operations management execution program 2011 is checked (step 901).

(4) Whether the alert has arrived from the query processing program 701 and whether the alert that has arrived matches the alert described in the execution timing field 1402 of the database operations management information 101 are checked (step 902).

(5) If it is determined in (4) that the alert has arrived and matches the alert described in the execution timing field 1402, the processing proceeds to (6); if it is determined that the alert has not arrived or that it has arrived but does not match the alert described in the execution timing field 1402, the processing is terminated.

(6) The alert reception flag is set to TRUE (step 1502).

(7) The current date and time are obtained from a system clock within a system program 2012 (step 603).

(8) Whether the current date and time obtained in (7) match, or are past, the date and time described in the execution timing field 1402 of the database operations management information 101 is checked (step 604).

(9) If it is determined in (8) that the current date and time match or are past the date and time described in the execution timing field 1402, the processing proceeds to (10); if it is determined that the current date and time neither match nor are past the date and time described in the execution timing field 1402, the processing is terminated.

(10) Programs that obtain internal information of a system or database, such as the database status analysis utility 1001 and/or the system status information acquisition program 1002, are called, and internal information of the system or database is obtained (step 1201).

(11) Whether the internal information of the system or database obtained meets the criterion described in the execution timing field 1402 of the database operations management information 101 is checked (step 1202).

(12) If it is determined in (11) that the internal information of the system or database obtained meets the criterion described in the execution timing field 1402, the processing proceeds to (13); if it is determined that the internal information of a system or database obtained does not meet the criterion, the processing is terminated.

(13) The group of database operations management utilities 2019 is activated in accordance with the instruction procedure described in the execution detail field 1403 of the database operations management information 101 (step 605).

(14) The alert reception flag is set to FALSE (step 1503).

The flowchart that indicates the overall processing procedure of a message transmission program 2020 according to the fourth embodiment of the present invention is the same as the flowchart in FIG. 17 according to the first embodiment.

As described above, according to the operations management method of database according to the present invention, database operations management information, whose execution timing is the occurrence of a phenomenon in which is designated a combination of the reception of a specific alert outputted by a query processing program, the arrival of a specific time or passage of a certain amount of time, and a certain condition regarding internal information of a system or database being met, is registered in a DBMS from an application or middleware, and the DBMS performs the operations management of the database in accordance with the database operations management information. As a result, users of the application or middleware can perform the operations management, which takes place when a predetermined condition regarding internal information of a system or database is met, without being directly aware of the DBMS.

According to the present invention, by registering in a DBMS from an application or middleware according to the requirements of an application or middleware the database operations management information that describes execution details of an operations management of a database performed by the DBMS, as well as an execution timing, which is expressed as the arrival of a specific time or passage of a certain amount of time, the reception of an alert outputted by a query processing program, a certain condition regarding internal information of a system or database being met, or a phenomenon combining these, users can perform the operations management of the database without being directly aware of the DBMS.

In addition, as a secondary effect of the users' being able to perform operations management of database without being directly aware of the DBMS, the operations management of the database can be performed without any intervention by the users acting as a database administrator, who is responsible for performing operations management of the database.

Furthermore, due to the fact that operations management can be performed on the database without any intervention by the database administrator, costs such as labor costs for the operations management of the database can be reduced, which reduces the overall cost required for the operations management of the database.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An operations management method for performing a operations management of a database, which is used by at least one of an application and a middleware, the operations management method comprising the steps of:
registering, in a DBMS database in response to an instruction from at least one of the application and the middleware, operations management information required for performing the operations management of the database;
making a judgment concerning the operations management information and starting operations management utilities of the DMBS based on the judgment made concerning the operations management information registered in the DBMS; and
transmitting from the DBMS a message concerning the operations management conducted to at least one of the application and the middleware.

2. An operations management method according to claim 1, wherein the step of registering the database operations management information includes the step of registering execution details information and execution timing information required for performing the operations management of the database, and the operations management of the database is conducted based on the execution details information and the execution timing information.

3. An operations management method according to claim 2, wherein the step of making a judgment includes the steps of determining an execution timing of the database operations management based on the database operations management information that is registered in the DMBS and starting the operations management utilities of the DMBS based on the execution timing determined.

4. An operations management method according to claim 2, wherein the execution timing information defines at least one specific time at which the database operations management is to be performed, and the database operations management is conducted at the specific time defined in the execution timing information.

5. An operations management method according to claim 4, wherein the least one specific time defines an execution beginning date and time.

6. An operations management method according to claim 2, wherein the execution timing information defines a specific time interval at which the database operations management is to be periodically performed, and the database operations management is periodically performed at the specific time interval defined in the execution timing information.

7. An operations management method according to claim 6, wherein the specific time interval defines an interval of period between executions of the data operations management.

8. An operations management method according to claim 6, wherein the execution timing information defines an expiration that indicates a date and time at which the repeated executions of the operations management is terminated.

9. An operations management method according to claim 2, wherein the execution timing information of the database operations management information defines an event when a specific alert is provided by a database query processing program, and the operations management of the database is conducted upon receiving the specific alert provided by the database query processing program.

10. An operations management method according to claim 9, wherein the specific alert refers to a notice issued by the query processing program regarding at least one failure that occurred inside the database.

11. An operations management method according to claim 10, wherein the failure that occurs inside the database refers to a specified level of insufficient database storage region.

12. An operations management method according to claim 10, wherein the failure that occurs inside the database refers to a specified level in reduction in database storage efficiency.

13. An operations management method according to claim 10, wherein the failure that occurs inside the database refers to a specified level of search efficiency.

14. An operations management method according to claim 10, wherein the notice is issued by the query processing program when a plurality of failures that occurred inside the database reaches a specified level.

15. An operations management method according to claim 10, wherein the notice is issued by the query processing program when one of a plurality of specified failures occurred inside the database.

16. An operations management method according to claim 2, wherein the execution timing information of the database operations management information defines an event when at least one condition designated for internal information of at least the database is established, and the database operations management is performed when the event takes place.

17. An operations management method according to claim 16, wherein the internal information of the database refers to at least one of status information, statistical information and operation information about the database.

18. An operations management method according to claim 2, wherein the execution timing information of the database operations management information defines an event when at least one condition designated for internal information of a database management system operated based on the operations management method is established, and the database operations management is performed when the event takes place.

19. An operations management method according to claim 18, wherein the internal information of the database management system refers to status information, statistical information and operation information about the database management system.

20. An operations management method according to claim 1, wherein the execution timing information of the database operations management information defines an event combining at least two of items of an arrival of a predetermined time, a passage of a predetermined time period, a reception of an alert outputted from a database query processing program, and an establishment of at least one predetermined condition of internal information of the database or a database management system operating the database, and the database operations management is performed when the event takes place.

21. An operations management method according to claim 1, wherein the database operations management information is inputted through at least one of the application and the middleware by using an input unit.

22. An operations management method according to claim 1, wherein an execution status of the database operations management based on the database operations management information is outputted to an output unit through at least one of the application and the middleware by using an input unit.

23. A storage medium that is readable by a computer and stores a program that executes an operations management method for performing a operations management of a database, which is used by at least one of an application and a middleware, the operations management method comprising the steps of:
registering, in a DBMS database in response to an instruction from at least one of the application and the middleware, operations management information including execution details information and execution timing information required for performing the operations management of the database;
making a judgment concerning an execution timing of the database operations management based on the operations management information and starting operations management utilities of the DMBS based on the judgment made concerning the execution timing; and
transmitting from the DBMS a message concerning the operations management conducted to at least one of the application and the middleware.

24. An operations management system for performing a operations management of a database, which is used by at least one of an application and a middleware, the operations management system comprising:
a unit that registers in a DBMS database in response to an instruction from at least one of the application and the middleware operations management information including execution details information and execution timing information required for performing the operations management of the database;
a unit that makes a judgment concerning an execution timing of the database operations management based on the operations management information and starts operations management utilities of the DMBS based on the judgment made concerning the execution timing; and
a unit that transmits from the DBMS a message concerning the operations management conducted to at least one of the application and the middleware.
